(19) United States
(12) Patent Application Publication
(10) Pub. No.: US 2006/0179205 A1
(43) Pub. Date: Aug. 10, 2006

(54) [EXPANDABLE INTEGRATED CIRCUIT AND OPERATION PROCEDURE THEREOF]

(75) Inventors: Hsiang-Hsiung Yu, TAIPEI (TW); Yi-Hsiang Huang, TAIPEI (TW); Chee-Kong Aw Yong, TAIPEI (TW)

Correspondence Address: PHISON ELECTRONICS CORPORATION, 2F-4. NO. 148, SEC. 4, CHUNG HSIAO EAST ROAD, TAIPEI, TW

(73) Assignee: PHISON ELECTRONICS CORP., Chutung Town, Hsinchu Hsien (TW)

(21) Appl. No.: 10/905,557

(22) Filed: Jan. 11, 2005

(51) Int. Cl. G06F 12/06

(52) U.S. Cl. 711/5

(57) ABSTRACT

An expandable integrated circuit (IC) and an operation procedure thereof are provided. The expandable IC comprises the CPU and a RAM for writing data or program for correction into the CPU so that the manufacturer need not replace the ROM when the data or program in IC needs to be corrected or modified. Therefore, not only the replacement cost of ROM can be avoided but also the recordable or executable program can be effectively expanded and thereby providing great convenience to the manufacturer.

### BACKGROUND OF THE INVENTION

1. The field of the invention

The present invention relates to an expandable integrated circuit (IC) and an operation procedure thereof, and more particularly to an expandable IC comprising the CPU and a DRAM for writing data or program for correction of program or data stored therein so that the manufacturer need not replace the ROM when the data or program in the IC needs to be corrected or modified. Therefore, not only the replacement cost of the ROM can be avoided but also the recordable or executable program can be effectively expanded and thereby providing great convenience to the manufacturer.

2. Description of related art

The 21^{st} century is a digital era and many traditional products have been replaced by the high-tech digital products because of the advantages and convenience provided by the high-tech digital products. In this digital era, most of the electronic appliances or utilities are related to the digital technology or controlled by the IC in order to achieve the desired automation and functions. Accordingly, the advanced digital knowledge and technology are required for controlling various high-tech products used in our daily life, for example, for controlling computer, television, audio/video system, central management of the building, automobile, aircraft and the like. Among the above items, the IC plays a very important role and that's why it is called the main food of the industry.

However, for mass production of IC, the manufacturers usually uses mask ROM as the memory of the IC and set a program counter to receive or preserve the address value of the memory required by the CPU. When the CPU sets the program counter, the content of the program counter is transmitted to the mask ROM for outputting the command or data stored therein for the CPU to read. Since the program or data of the above IC are stored in the mask ROM, if any further modification of the program or data is desired, the mask ROM has to be replaced. Therefore, the time spent for replacement of the mask ROM and cost of the replacement of the mask ROM is quite high. Furthermore, there is no solution to resolve when error is found in the program or data after installation of the IC in the electronic appliance except to replace the mask ROM. Accordingly, replacement of the whole unit would be inevitable and therefore the cost to the manufacturer/user would be higher.

Accordingly, the above defects of the conventional design are important issues for the manufacturers of the field to improve.

### SUMMARY OF THE INVENTION

Accordingly, in the view of the foregoing, the present inventor makes a detailed study of related art to evaluate and consider, and uses years of accumulated experience in this field, and through several experiments to create a new expandable integrated circuit. The present invention provides an innovated cost effective expandable integrated circuit (IC) capable of expanding the recordable or executable program in the IC.

According to an aspect of the present invention, the address buffer and the dynamic buffer are used for supporting the program counter for allowing the CPU to use the data or program stored in the RAM, and therefore the manufacturer need not replace the mask ROM of the whole IC. Therefore the cost on replacement of the mask ROM can be effectively avoided. Therefore, the recordable or executable program in the IC can be expanded, and thus the electronic appliances with few program differences can share the same IC without using large quantity of expensive RAM for storing all the programs but rather only storing the programs for correction.

### BRIEF DESCRIPTION OF THE DRAWING

For a more complete understanding of the present invention, reference will now be made to the following detailed description of preferred embodiments taken in conjunction with the following accompanying drawings.

FIG. 1 is a block diagram of an expandable integrated circuit according to an embodiment of the present invention.

FIG. 2 is a flowchart illustrating an operation procedure of the integrated circuit according to an embodiment of the present invention.

### DETAILED DESCRIPTION OF EMBODIMENTS

Reference will be made in detail to the preferred embodiments of the invention, examples of which are illustrated in the accompanying drawings. Wherever possible, the same reference numbers are used in the drawings and the description to refer to the same or like parts.

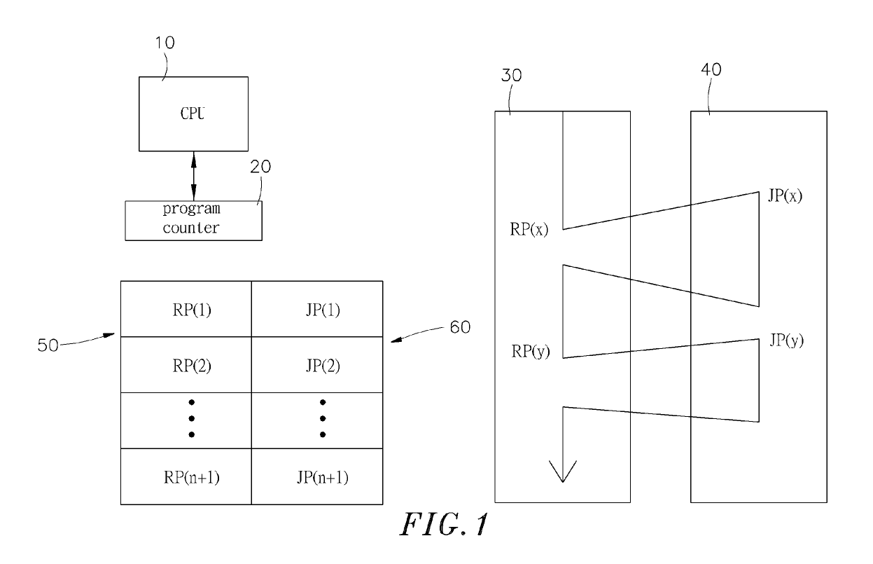

Referring to FIG. 1, the expandable IC comprises a CPU 10, a program counter 20, a ROM 30, a RAM 40, an address comparing register 50 and a target addressing register 60.

The CPU 10 can be set up with a program counter 20.

The program counter 20 is capable of storing address of data or program to be read by the CPU 10.

The ROM 30 is a read only memory where the data stored therein can be read.

The RAM 40 is a random access memory which is rewritable or reprogrammable.

The set of address comparing register 50 is adapted for storing one or more than one address of the RAM 40.

The set of target addressing register 60 is adapted for storing one or more than one address of the RAM 40 that can be written into the program counter 20.

When a user wishes to modify data or program in the IC, first, the desired data or program is written into the RAM 40 and address of the desired data or program written in the RAM 40 is then stored into the address comparing register 50. Next, the address corresponding to the address comparing register 50 is stored in the target addressing register 60.

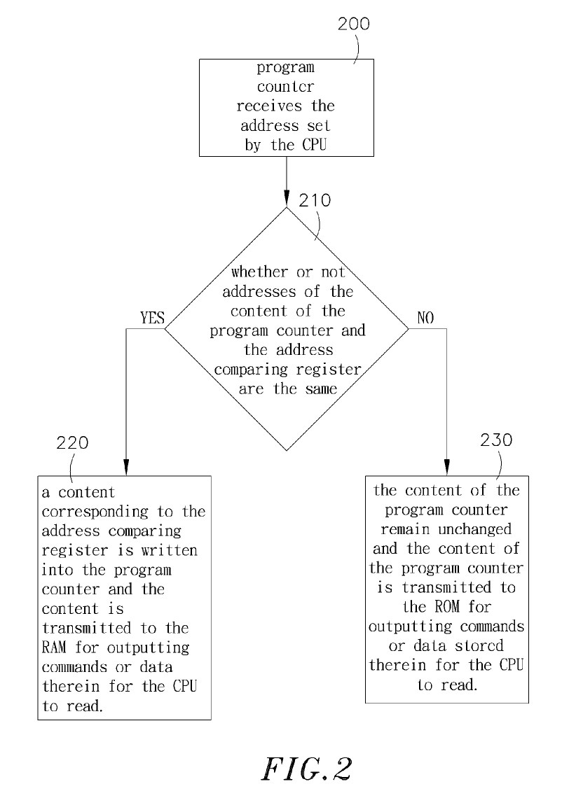

The operation procedure of the CPU 10 can be described with reference with FIGS. 1 and 2 as follows.

At step 200, the CPU 10 sets the program counter 20 to fetch the command or data.

At step 210, the addresses of the content of the program counter 20 and the address comparing register 50 are compared to judge whether or not the addresses of the both are same, wherein if yes, the procedure proceeds to step 220, if not, the procedure proceeds to step 230.

At step 220, a content of the target addressing register 60 corresponding to the address comparing register 50 is written into the program counter 20, and the content of the program counter 20 is transmitted to the RAM 40 for outputting the command or data stored therein for the CPU 10 to read.

At step 230, the content of the program counter 20 is unchanged and the content of the program counter 20 is transmitted to the ROM 30 for outputting the command or data stored therein for the CPU 10 to read.

Furthermore, the program or data written into the RAM 40 can be downloaded from a memory card, a flash memory or a USB, and the program in the RAM 40 can call the program stored in the ROM 30 or can read the data stored therein.

For ensuring that the program or data written into the RAM 40 is not altered due to an error in the storage media or the downloading process, an extra data for automatic repair or error correction can also be applied to the program or data.

The ROM 30, according to an embodiment of the present invention, can be a mask ROM or a PROM.

According to the above description, the key feature of the expandable IC of the present invention comprises the RAM 40 for storing the modified or added program for correcting or modifying program or data in the IC, and use the content of the address comparing register 50 and the target addressing register 60 to set up the program counter 20 for enabling the CPU 10 to use the data or program stored in the RAM 40. When modification of the program or data in the IC is desired, the ROM 30 of the whole IC need not be replaced in order to save the cost of replacement. Besides, this is capable of expanding the recordable or executable program in the IC. Accordingly, the electronic appliances with few program differences can share the same IC, and the manufacturer need not use the expensive RAM 40 for storing all the programs, instead only need to store the program for correction.

While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations in which fall within the spirit and scope of the included claims. All matters set forth herein or shown in the accompanying drawings are to be interpreted in an illustrative and non-limiting sense.

What is claimed is:

1. An operation of expandable integrated circuit (IC), the expandable IC comprising:
a CPU, for setting up a programmable timer, wherein said programmable timer is adapted for recording addresses of data or program readable by said CPU;
a ROM, for only reading out but not for writing in;
a RAM, for repeatedly writing data or program;
a set of address comparing register, for storing one or more than one address of said RAM; and
a set of target addressing register, for storing one or more than one address of said RAM and writing into said programmable timer; the operation comprising:
issuing a reading command, wherein said CPU issues said reading command; and
matching addresses of said address comparing register with a content of said program counter, wherein if addresses of said address comparing register and said content of said program counter are found to be same, said program counter copies the content of said target addressing register, and wherein the corresponding data or program can be reached by said CPU.

2. The operation of expandable IC according to claim 1, wherein said ROM can be a mask ROM.

3. The operation of expandable IC according to claim 1, wherein said ROM can be a PROM.

4. The operation of expandable IC according to claim 1, wherein said RAM can be a PRAM.

5. The operation of expandable IC according to claim 1, wherein said RAM can be a RAM.

6. An operation of expandable IC comprising a CPU, a program counter, a set of address comparing register, a set of target addressing register, a ROM and a RAM, comprising:
(a) setting up said program counter, wherein said CPU sets up said program counter,
(b) matching a content of said program counter and said address comparing register to judge whether or not addresses of said content of said program counter and said address comparing register are same, wherein when addresses of said content of said program counter and said address comparing register are found to be same, the operation proceeds to step (c); and
(c) copy the content of said target addressing register corresponding to said address comparing register into said program counter and transmitting the content of said program counter to said RAM for outputting commands or data stored therein to enable said CPU to read.

7. The operation of expandable IC according to claim 6, wherein when addresses of said content of said program counter and said address comparing register are not found to be same, the operation proceeds to step (d), wherein said content of said program counter is unchanged and said content of said program counter is transmitted to said ROM for outputting commands or data stored therein to enable said CPU to read.
